(19) United States
(12) Patent Application Publication
(10) Pub. No.: US 2026/0317239 A1
(43) Pub. Date: Oct. 15, 2026

(54) CARBON COMPOSITE CERAMIC LINEAR RESISTOR AND PREPARATION METHOD THEREOF

(71) Applicant: Xianyang Yahua Electronic Apparatus Co., Ltd, Xianyang (CN)

(72) Inventors: Jianfeng Yang, Xianyang (CN); Dongbin Jiang, Xianyang (CN); Bo Wang, Xianyang (CN); Gongzhi Liu, Xianyang (CN); Chunfang Li, Xianyang (CN); Hongyuan Zhang, Xianyang (CN); Bo Zhao, Xianyang (CN)

(21) Appl. No.: 19/361,480

(22) Filed: Oct. 17, 2025

(30) Foreign Application Priority Data
Apr. 14, 2025 (CN) 2025104579384

(51) Int. Cl. C04B 35/565; C04B 33/04; C04B 33/13; C04B 33/32; C04B 35/626; C04B 35/628; C04B 35/634; H01C 17/00

(52) U.S. Cl. CPC C04B 35/565; C04B 33/04; C04B 33/131; C04B 33/32; C04B 35/6262; C04B 35/6263; C04B 35/6264; C04B 35/62655; C04B 35/62675; C04B 35/62842; C04B 35/62897; C04B 35/63416; H01C 17/00; C04B 2235/349; C04B 2235/3826; C04B 2235/422; C04B 2235/604; C04B 2235/6567; C04B 2235/658

(57) ABSTRACT

A carbon composite ceramic linear resistor and a preparation method thereof are provided. The preparation method includes the following steps. Bentonite, silicon carbide and nano carbon black are mixed to obtain a powder mixture. The powder mixture and ethyl alcohol are mixed uniformly, and dried to obtain a uniformly mixed powder. A binder solution is added to the uniformly mixed powder to obtain a mixture. The green body obtained by die-pressing is heated to a temperature ranging from 1150 Celsius degrees (° C.) to 1300° C. in a nitrogen-containing gas atmosphere, and the temperature is kept to obtain a sample. The sample is ground to obtain a ground sample. Then aluminum is sprayed on the ground sample to obtain the carbon composite ceramic linear resistor. The preparation method can be used to reduce electrical resistivity and increase thermal shock resistance of the carbon composite ceramic linear resistor.

### CROSS-REFERENCE TO RELATED APPLICATION

This application claims priority to Chinese Patent Application No. 202510457938.4, filed on Apr. 14, 2025. The entire contents of the above-mentioned application are incorporated herein by reference.

### TECHNICAL FIELD

The disclosure relates to the technical field of power electronic components, and more particularly to a carbon composite ceramic linear resistor and a preparation method thereof.

### BACKGROUND

Carbon composite alumina ceramic linear resistors in the related art are fabricated by sintering a mixture of alumina as an aggregate, clay as a sintering aid, and a conductive carbon material. With the development of ultra-high voltage technologies, there is a need for ceramic linear resistors to withstand more energy, leading the resistive materials to endure significant temperature differences in a short period. The poor thermal shock resistance of the ceramic linear resistors in the related art can make them crack under such extreme thermal stresses caused by the significant temperature differences. As the application range of carbon-ceramic resistors expands, there is an increasing demand for lower resistivity, typically achieved by increasing the carbon content. However, excessively high carbon content makes it difficult to sinter the clay, hindering the reduction in resistivity. For instance, Chinese Patent Application No. CN202210706840.4 (with the publication number of CN114937537A), titled “A Carbon Ceramic Switching Resistor and Its Preparation Process,” mentions modifying highly conductive carbon black to improve dispersion and employing isostatic compaction to reduce resistance. Nevertheless, increasing the carbon black content further does not significantly change the material's resistance. In the study “Preparation and Properties of Graphite/Ceramic Composite Conductive Materials” published in Acta Materiae Compositae Sinica (2009, Vol. 26, No. 4), Xin Zheng et al. reported that increasing flake graphite content to above 15 weight percent (wt %) can obtain ceramic resistors with resistivity in the range of 1 ohm-centimeter (Ω·cm) to 3 Ω·cm. Nonetheless, such high graphite content drastically deteriorates the mechanical properties of the material, making it unsuitable for high-voltage service environments. Apart from adjusting carbon sources to control resistivity, current technologies also modify clays to enhance sintering performance. For example, Chinese Patent Application No. CN202110120534.8 (with the publication number of CN114804834A), titled “A Low-Temperature Sintered Carbon Composite Ceramic Linear Resistor and Its Preparation Method,” addresses improving the thermal shock resistance of the ceramic linear resistors by enhancing thermal conductivity. However, the alumina aggregates in the related art have low thermal conductivity, and the porousness required for linear resistors limits further enhancement in thermal conductivity. According to literature research, silicon carbide-based multiphase ceramic materials possess both high thermal conductivity and certain electrical conductivity.

Chinese Patent Application No. CN201610410680.3 (with the publication number of CN106083057A), titled “A Silicon Carbide-Based Multiphase Ceramic Material and Its Preparation Method,” describes using pressureless sintering technology to prepare dense silicon carbide/zirconium diboride ceramics. Zirconium diboride is introduced as a second phase into silicon carbide, followed by sintering at 2100° C. in argon (Ar) atmosphere under normal pressure, and the resistivity is adjusted by controlling the content of the second phase of zirconium diboride. Nevertheless, a nonlinearity coefficient of the dense silicon carbide/zirconium diboride ceramics reaches up to 1.66, making it unsuitable for use as a linear resistor.

Another Chinese Patent Application No. CN201610367998.8 (with the publication number of CN106045520A), titled “A Silicon Carbide/Graphite Composite Material with Low Resistivity and Linear Resistance Characteristics and Its Preparation Method,” employs pressureless sintering technology to prepare silicon carbide/graphite ceramics. Carbon is introduced through organic carbon sources and amorphous carbon, followed by sintering at 2200° C. to convert the carbon phase into graphite, and the resistivity is adjusted by controlling the graphite content. By controlling the graphite content, the resistivity can be adjusted and the silicon carbide/graphite ceramics can exhibit linear current-voltage characteristics. At low resistivity levels, carbon content can reach up to 20 wt %, and the preparation process is complex.

In summary, while silicon carbide-based multiphase ceramic materials achieve low resistivity and linear resistance features along with high thermal conductivity, their linear characteristics and low resistivity cannot be separated from their relatively high density, rendering them unsuitable for high-power linear resistors. Moreover, the high sintering temperatures and complex preparation processes result in high production costs. In composite systems, the adjustment of resistivity is achieved by modifying the content of the high-conductivity second phase. Given that silicon carbide itself has a resistivity as high as 10⁵ Ω·cm, the contribution of silicon carbide to resistivity control is minimal, primarily serving to form the framework within the composite system.

### SUMMARY

In view of this, an objective of the disclosure is to provide a preparation method of a carbon composite ceramic linear resistor to reduce electrical resistivity and increase thermal shock resistance. The disclosure uses silicon carbide as both an aggregate and a conductive phase, bentonite as a sintering aid, and nano carbon black as a conductive filler. The raw materials are mixed and molded, followed by sintering under a high-temperature nitrogen atmosphere to produce the carbon composite ceramic linear resistor. Through a nitrogen treatment, the silicon carbide is effectively combined with the bentonite and the nano carbon black, reducing the electrical resistivity of the carbon composite ceramic linear resistor. On the other hand, the silicon carbide possesses a low coefficient of thermal expansion and good thermal conductivity, which reduces the thermal stress generated in the carbon composite ceramic linear resistor due to temperature changes, thereby improving the thermal shock resistance of the carbon composite ceramic linear resistor.

A first aspect of the disclosure provides a preparation method of a carbon composite ceramic linear resistor, including the following steps.

Bentonite, silicon carbide and nano carbon black are mixed uniformly to obtain a powder mixture. The powder mixture and ethyl alcohol are mixed uniformly to obtain a uniformly mixed powder. A binder solution is added to the uniformly mixed powder to obtain a mixture. Then a green body (also referred to as green compact) is formed using the mixture by performing compression molding.

The green body is held at a temperature ranging from 1150 Celsius degrees (° C.) to 1300° C. under a nitrogen-containing gas atmosphere, thereby obtaining a sample. It should be noted that when the temperature is raised to above 1100° C., a heating rate decreases to ensure uniform temperature in a furnace.

The sample is ground to obtain a ground sample. Then aluminum is sprayed on the ground sample to obtain the carbon composite ceramic linear resistor.

In some embodiments, the powder mixture includes the following components by volume percentage: 33% to 56% of the bentonite, 40% to 60% of the silicon carbide, 1% to 7% of the nano carbon black, with a total volume amounting to 100%.

For example, a volume percentage of the bentonite can be 33%, 36%, 38%, 40%, 42%, 44%, 46%, 48%, 50%, 52%, 54%, 56%.

A volume percentage of the silicon carbide can be 40%, 42%, 44%, 46%, 48%, 50%, 52%, 54%, 56%, 58%, 60%.

A volume percentage of the nano carbon black can be 1%, 2%, 3%, 4%, 5%, 6%, 7%. It is not limited to the listed values, other values not listed within the above range are also applicable.

In some embodiments, time for holding the temperature is in a range of 2 hours (h) to 4 h. For example, the time for holding the temperature is 2 h, 2.5 h, 3 h, 3.5 h, 4 h.

In some embodiments, a rate of heating the green body is in a range of 5 Celsius degrees per minute (° C./min) to 10° C./min. For example, the rate of heating the green body can be 5° C./min, 6° C./min, 7° C./min, 8° C./min, 9° C./min, 10° C./min. It is not limited to the listed values, other values not listed within the above range are also applicable.

In some embodiments, pressure of the compression molding method is in a range of 75 megapascals (MPa) to 100 MPa. For example, the pressure of the green body forming can be 75 MPa, 80 MPa, 85 MPa, 90 MPa, 95 MPa, 100 MPa, etc.

In some embodiments, an addition amount of the binder solution is in a range of 5% to 10% of a mass of the powder mixture, and a mass concentration of the binder solution is 5%.

For example, the addition amount of the binder solution can be 5%, 6%, 7%, 8%, 9%, 10% of a mass of the powder mixture. It is not limited to the listed values, other values not listed within the above range are also applicable.

In some embodiments, the binder solution includes polyvinyl alcohol.

In some embodiments, a volume ratio of the powder mixture and the ethyl alcohol is in a range of 3:1 to 3.5:1. For example, the volume ratio of the powder mixture and the ethyl alcohol can be 3:1, 3.1:1, 3.2:1, 3.3:1, 3.4:1, 3.5:1.

In some embodiments, mixing the powder mixture and the ethyl alcohol includes: mixing at a ball-milling speed ranging from 100 revolutions per minutes (rpm) to 300 rpm for 10 h to 16 h.

For example, the ball-milling speed can be 100 rpm, 150 rpm, 200 rpm, 250 rpm, 300 rpm. Time of the mixing the powder mixture and the ethyl alcohol can be 10 h, 11 h, 12 h, 13 h, 14 h, 15 h, 16 h, etc. It is not limited to the listed values, other values not listed within the above range are also applicable.

In some embodiments, a thickness of the aluminum is sprayed on the ground sample by spraying is in a range of 10 micrometers (μm) to 15 μm. For example, the thickness can be 10 μm, 11 μm, 12 μm, 13 μm, 14 μm, 15 μm.

A second aspect of the disclosure provides a carbon composite ceramic linear resistor prepared by the method mentioned above.

The disclosure discloses the following technical effects compared to technical solutions in the related art.

The disclosure uses the bentonite, the silicon carbide, and the nano carbon black as raw materials. The silicon carbide serves both as a ceramic aggregate and a conductive phase. Both the silicon carbide and the nano carbon black possess excellent electrical conductivity, while the silicon carbide also exhibits superior thermal conductivity, a low coefficient of thermal expansion, and stable physicochemical properties. The silicon carbide and the bentonite are readily available and can form porous ceramics. Carbon composite ceramic linear resistor prepared in the disclosure possesses lower electrical resistivity, high operating temperatures, and strong thermal shock resistance. The bentonite forms a liquid phase above 1000° C., bonding the silicon carbide with glass to create conductive pathways without high density. This significantly shortens a preparation process duration. Sintering is performed at a temperature ranging from 1150° C. to 1300° C., effectively reducing the total sintering time. Moreover, the green body in the disclosure does not require a debonding treatment, further saving time.

Intrinsic electrical resistivity of the silicon carbide is approximately 10⁵ ohm-centimeters (Ω·cm). In the related art, adjustment of electrical resistivity and current-voltage characteristics is achieved by increasing a content of highly conductive secondary phases. At this point, the silicon carbide contributes minimally to changes in electrical resistivity. However, through a treatment under a nitrogen-containing gas atmosphere at a high temperature, the disclosure achieves N-type doping of silicon carbide semiconductors, effectively lowering the intrinsic resistivity of the silicon carbide. After N-type doping, the silicon carbide itself, as well as between the silicon carbide and the nano carbon black, can form conductive pathways similar to those formed between particles of the nano carbon black, thereby making the silicon carbide act as a conductive phase.

Compared with the related art, the preparation method of the carbon composite ceramic linear resistor according to the disclosure features simple processes, easily accessible raw materials, and low production costs. The carbon composite ceramic linear resistor exhibits low resistivity, a wide range of operating temperatures, and strong thermal shock resistance.

### BRIEF DESCRIPTION OF DRAWING

FIGURE illustrates a voltage-current curve diagram of a carbon composite ceramic linear resistor according to an embodiment 1.

### DETAILED DESCRIPTION OF EMBODIMENTS

Technical solutions of embodiments of the disclosure will be described below in conjunction with the accompanying drawings of the embodiments of the disclosure. It is apparent that the described embodiments are merely a part of the embodiments of the disclosure, rather than all of the embodiments. Based upon the embodiments of the disclosure, all other embodiments obtained by those skilled in the art without making any creative effort shall fall within the scope of protection of the disclosure.

Particle sizes of silicon carbide used in the disclosure include 62.5 micrometers (μm) and 10 μm. A volume ratio of the silicon carbide with the particle size of 62.5 μm to the silicon carbide with the particle size of 10 μm is 2:1. By selecting silicon carbide particles of different particle sizes and employing particle size grading, density of a green body can be increased, thereby reducing a shrinkage rate of the green body during sintering.

The molecular weight of polyvinyl alcohol used in the disclosure is 9000 to 10000.

Particle size of nano carbon black of the disclosure is 27 nanometers (nm). Particle size of bentonite of the disclosure is 5 μm.

In the disclosure, vol % denotes volume percent, and wt % denotes weight percent.

### Embodiment 1

A preparation method of a carbon composite ceramic linear resistor is provided in the embodiment, including the following steps 1-5.

In step 1: pretreatment of raw materials is as follows. Silicon carbide powder, bentonite and nano carbon black are placed in an oven for drying at 80 Celsius degrees (° C.) for 2 hours (h).

In step 2: 60 vol % of the silicon carbide powder, 36 vol % of the bentonite and 4 vol % of the nano carbon black are measured accurately. The silicon carbide powder, the nano carbon black and the bentonite are mixed to obtain a powder mixture. Anhydrous ethanol is measured according to a volume ratio of 3:1 relative to the powder mixture. The powder mixture and the anhydrous ethanol are placed into a ball mill. The powder mixture and the anhydrous ethanol are mixed and ball-milled at a rotational speed of 200 revolutions per minute (rpm) for 12 h, then dried and sieved to obtain a uniformly mixed powder.

In step 3: a 5 wt % polyvinyl alcohol solution is added to the uniformly mixed powder to obtain a mixture. An addition amount of the polyvinyl alcohol solution is 10% of a mass of the uniformly mixed powder. The mixture is used to form a green body through a compression molding method (also referred to a die-pressing method). The compression molding method includes subjecting the mixture to a pressure of 75 megapascals (MPa) in a bidirectional pressing mode with a holding time of 60 seconds to obtain the green body. Then the green body is placed in the oven for drying at 100° C. for 12 h.

In step 4: the green body prepared in the step 3 is placed in a graphite crucible, then the graphite crucible is placed in a multi-functional sintering furnace. Nitrogen gas is introduced into the multi-functional sintering furnace as a protective atmosphere. The graphite crucible is firstly heated from room temperature to a first temperature of 1100° C. at a rate of 10 Celsius degrees per minute (° C./min), then heated from the first temperature of 1100° C. to a second temperature of 1150° C. at a rate of 5° C./min, and the second temperature is kept for 2 h, finally the graphite crucible is cooled down to the room temperature with the multi-functional sintering furnace to obtain a sample.

In step 5: surface of the sample obtained in the step 4 is ground to obtain a ground sample, using sandpapers of 200 mesh, 400 mesh and 800 mesh in sequence. Aluminum is then sprayed onto top and bottom surfaces of the ground sample using a thermal spray machine to a thickness of 10 μm, then dried in the oven at a temperature of 100° C. to obtain the carbon composite ceramic linear resistor.

### Embodiment 2

A preparation method of a carbon composite ceramic linear resistor is provided in the embodiment, including the following steps 1-5.

In step 1: pretreatment of raw materials is as follows. Silicon carbide powder, bentonite and nano carbon black are placed in an oven for drying at 80° C. for 2 h.

In step 2: 50 vol % of the silicon carbide powder, 46 vol % of the bentonite and 4 vol % of the nano carbon black are measured accurately. The silicon carbide powder, the nano carbon black and the bentonite are mixed to obtain a powder mixture. Anhydrous ethanol is measured according to a volume ratio of 3:1 relative to the powder mixture. The powder mixture and the anhydrous ethanol are placed into a ball mill. The powder mixture and the anhydrous ethanol are mixed and ball-milled at a rotational speed of 200 rpm for 12 h, then dried and sieved to obtain a uniformly mixed powder.

In step 3: a 5 wt % polyvinyl alcohol solution is added to the uniformly mixed powder to obtain a mixture. An addition amount of the polyvinyl alcohol solution is 10% of a mass of the uniformly mixed powder. The mixture is used to form a green body through a compression molding method. The compression molding method includes subjecting the mixture to a pressure of 75 MPa in a bidirectional pressing mode with a holding time of 60 seconds to obtain the green body. Then the green body is placed in the oven for drying at 100° C. for 12 h.

In step 4: the green body prepared in the step 3 is placed in a graphite crucible, then the graphite crucible is placed in a multi-functional sintering furnace. Nitrogen gas is introduced into the multi-functional sintering furnace as a protective atmosphere. The graphite crucible is firstly heated from room temperature to a first temperature of 1100° C. at a rate of 10° C./min, then heated from the first temperature of 1100° C. to the second temperature of 1150° C. at a rate of 5° C./min, and the second temperature is kept for 2 h, finally the graphite crucible is cooled down to the room temperature with the multi-functional sintering furnace to obtain a sample.

In step 5: surface of the sample obtained in the step 4 is ground to obtain a ground sample, using sandpapers of 200 mesh, 400 mesh and 800 mesh in sequence. Aluminum is then sprayed onto top and bottom surfaces of the ground sample using a thermal spray machine to a thickness of 10 μm then dried in the oven at a temperature of 100° C. to obtain the carbon composite ceramic linear resistor.

### Embodiment 3

A preparation method of a carbon composite ceramic linear resistor is provided in the embodiment, including the following steps 1-5.

In step 1: pretreatment of raw materials is as follows. Silicon carbide powder, bentonite and nano carbon black are placed in an oven for drying at 80° C. for 2 h.

In step 2: 40 vol % of the silicon carbide powder, 56 vol % of the bentonite and 4 vol % of the nano carbon black are measured accurately. The silicon carbide powder, the nano carbon black and the bentonite are mixed to obtain a powder mixture. Anhydrous ethanol is measured according to a volume ratio of 3:1 relative to the powder mixture. The powder mixture and the anhydrous ethanol are placed into a ball mill. The powder mixture and the anhydrous ethanol are mixed and ball-milled at a rotational speed of 200 rpm for 12 h, then dried and sieved to obtain a uniformly mixed powder.

In step 3: a 5 wt % polyvinyl alcohol solution is added to the uniformly mixed powder to obtain a mixture. An addition amount of the polyvinyl alcohol solution is 10% of a mass of the uniformly mixed powder. The mixture is used to form a green body through a compression molding method. The compression molding method includes subjecting the mixture to a pressure of 75 MPa in a bidirectional pressing mode with a holding time of 60 seconds to obtain the green body. Then the green body is placed in the oven for drying at 100° C. for 12 h.

In step 4: the green body prepared in the step 3 is placed in a graphite crucible, then the graphite crucible is placed in a multi-functional sintering furnace. Nitrogen gas is introduced into the multi-functional sintering furnace as a protective atmosphere. The graphite crucible is firstly heated from room temperature to a first temperature of 1100° C. at a rate of 10° C./min, then heated from the first temperature of 1100° C. to a second temperature of 1150° C. at a rate of 5° C./min, and the second temperature is kept for 2 h, finally the graphite crucible is cooled down to the room temperature with the multi-functional sintering furnace to obtain a sample.

In step 5: a surface of the sample obtained in the step 4 is ground to obtain a ground sample, using sandpapers of 200 mesh, 400 mesh and 800 mesh in sequence. Aluminum is then sprayed onto top and bottom surfaces of the ground sample using a thermal spray machine to a thickness of 10 μm, then dried in the oven at a temperature of 100° C. to obtain the carbon composite ceramic linear resistor.

### Embodiment 4

A preparation method of a carbon composite ceramic linear resistor is provided in the embodiment, including the following steps 1-5.

In step 1: pretreatment of raw materials is as follows. Silicon carbide powder, bentonite and nano carbon black are placed in an oven for drying at 80° C. for 2 h.

In step 2: 60 vol % of the silicon carbide powder, 33 vol % of the bentonite and 7 vol % of the nano carbon black are measured accurately. The silicon carbide powder, the nano carbon black and the bentonite are mixed to obtain a powder mixture. Anhydrous ethanol is measured according to a volume ratio of 3:1 relative to the powder mixture. The powder mixture and the anhydrous ethanol are placed into a ball mill. The powder mixture and the anhydrous ethanol are mixed and ball-milled at a rotational speed of 200 rpm for 12 h, then dried and sieved to obtain a uniformly mixed powder.

In step 3: a 5 wt % polyvinyl alcohol solution is added to the uniformly mixed powder to obtain a mixture. An addition amount of the polyvinyl alcohol solution is 10% of a mass of the uniformly mixed powder. The mixture is used to form a green body through a compression molding method. The compression molding method includes subjecting the mixture to a pressure of 75 MPa in a bidirectional pressing mode with a holding time of 60 seconds to obtain the green body. Then the green body is placed in the oven for drying at 100° C. for 12 h.

In step 4: the green body prepared in the step 3 is placed in a graphite crucible, then the graphite crucible is placed in a multi-functional sintering furnace. Nitrogen gas is introduced into the multi-functional sintering furnace as a protective atmosphere. The graphite crucible is firstly heated from room temperature to a first temperature of 1100° C. at a rate of 10° C./min, then heated from the first temperature of 1100° C. to a second temperature of 1150° C. at a rate of 5° C./min, and the second temperature is kept for 2 h, finally the graphite crucible is cooled down to the room temperature with the multi-functional sintering furnace to obtain a sample.

In step 5: a surface of the sample obtained in the step 4 is ground to obtain a ground sample, using sandpapers of 200 mesh, 400 mesh and 800 mesh in sequence. Aluminum is then sprayed onto top and bottom surfaces of the ground sample using a thermal spray machine to a thickness of 10 μm, then dried in the oven at a temperature of 100° C. to obtain the carbon composite ceramic linear resistor.

### Embodiment 5

A preparation method of a carbon composite ceramic linear resistor is provided in the embodiment, including the following steps 1-5.

In step 1: pretreatment of raw materials is as follows. Silicon carbide powder, bentonite and nano carbon black are placed in an oven for drying at 80° C. for 2 h.

In step 2: 60 vol % of the silicon carbide powder, 39 vol % of the bentonite and 1 vol % of the nano carbon black are measured accurately. The silicon carbide powder, the nano carbon black and the bentonite are mixed to obtain a powder mixture. Anhydrous ethanol is measured according to a volume ratio of 3:1 relative to the powder mixture. The powder mixture and the anhydrous ethanol are placed into a ball mill. The powder mixture and the anhydrous ethanol are mixed and ball-milled at a rotational speed of 200 rpm, then dried and sieved to obtain a uniformly mixed powder.

In step 3: a 5 wt % polyvinyl alcohol solution is added to the uniformly mixed powder to obtain a mixture. An addition amount of the polyvinyl alcohol solution is 10% of a mass of the uniformly mixed powder. The mixture is used to form a green body through a compression molding method. The compression molding method includes subjecting the mixture to a pressure of 75 MPa in a bidirectional pressing mode with a holding time of 60 seconds to obtain the green body. Then the green body is placed in the oven for drying at 100° C. for 12 h.

In step 4: the green body prepared in the step 3 is placed in a graphite crucible, then the graphite crucible is placed in a multi-functional sintering furnace. Nitrogen gas is introduced into the multi-functional sintering furnace as a protective atmosphere. The graphite crucible is firstly heated from room temperature to a first temperature of 1100° C. at a rate of 10° C./min, then heated from the first temperature of 1100° C. to a second temperature of 1150° C. at a rate of 5° C./min, and the second temperature is kept for 2 h, finally the graphite crucible is cooled down to the room temperature with the multi-functional sintering furnace to obtain a sample.

In step 5: a surface of the sample obtained in the step 4 is ground to obtain a ground sample, using sandpapers of 200 mesh, 400 mesh and 800 mesh in sequence. Aluminum is then sprayed onto top and bottom surfaces of the ground sample using a thermal spray machine to a thickness of 10 μm, then dried in the oven at a temperature of 100° C. to obtain the carbon composite ceramic linear resistor.

### Embodiment 6

A preparation method of a carbon composite ceramic linear resistor is provided in the embodiment, including the following steps 1-5.

In step 1: pretreatment of raw materials is as follows. Silicon carbide powder, bentonite and nano carbon black are placed in an oven for drying at 80° C. for 2 h.

In step 2: 60 vol % of the silicon carbide powder, 36 vol % of the bentonite and 4 vol % of the nano carbon black are measured accurately. The silicon carbide powder, the nano carbon black and the bentonite are mixed to obtain a powder mixture. Anhydrous ethanol is measured according to a volume ratio of 3:1 relative to the powder mixture. The powder mixture and the anhydrous ethanol are placed into a ball mill. The powder mixture and the anhydrous ethanol are mixed and ball-milled at a rotational speed of 200 rpm for 12 h, then dried and sieved to obtain a uniformly mixed powder.

In step 3: a 5 wt % polyvinyl alcohol solution is added to the uniformly mixed powder to obtain a mixture. An addition amount of the polyvinyl alcohol solution is 10% of a mass of the uniformly mixed powder. The mixture is used to form a green body through a compression molding method. The compression molding method includes subjecting the mixture to a pressure of 75 MPa in a bidirectional pressing mode with a holding time of 60 seconds to obtain the green body. Then the green body is placed in the oven for drying at 100° C. for 12 h.

In step 4: the green body prepared in the step 3 is placed in a graphite crucible, then the graphite crucible is placed in a multi-functional sintering furnace. Nitrogen gas is introduced into the multi-functional sintering furnace as a protective atmosphere. The graphite crucible is firstly heated from room temperature to a first temperature of 1100° C. at a rate of 10° C./min, then heated from the first temperature of 1100° C. to a second temperature of 1200° C. at a rate of 5° C./min, and the second temperature is kept for 2 h, finally the graphite crucible is cooled down to the room temperature with the multi-functional sintering furnace to obtain a sample.

In step 5: a surface of the sample obtained in the step 4 is ground to obtain a ground sample, using sandpapers of 200 mesh, 400 mesh and 800 mesh in sequence. Aluminum is then sprayed onto top and bottom surfaces of the ground sample using a thermal spray machine to a thickness of 10 μm, then dried in the oven at a temperature of 100° C. to obtain the carbon composite ceramic linear resistor.

### Embodiment 7

A preparation method of a carbon composite ceramic linear resistor is provided in the embodiment, including the following steps 1-5.

In step 1: pretreatment of raw materials is as follows. silicon carbide powder, the bentonite and the nano carbon black are placed in an oven for drying at 80° C. for 2 h.

In step 2: 60 vol % of the silicon carbide powder, 36 vol % of the bentonite and 4 vol % of the nano carbon black are measured accurately. The silicon carbide powder, the nano carbon black and the bentonite are mixed to obtain a powder mixture. Anhydrous ethanol is measured according to a volume ratio of 3:1 relative to the powder mixture. The powder mixture and the anhydrous ethanol are placed into a ball mill. The powder mixture and the anhydrous ethanol are mixed and ball-milled at a rotational speed of 200 rpm for 12 h, then dried and sieved to obtain a uniformly mixed powder.

In step 3: a 5 wt % polyvinyl alcohol solution is added to the uniformly mixed powder to obtain a mixture. An addition amount of the polyvinyl alcohol solution is 10% of a mass of the uniformly mixed powder. The mixture is used to form a green body through a compression molding method. The compression molding method includes subjecting the mixture to a pressure of 75 MPa in a bidirectional pressing mode with a holding time of 60 seconds to obtain the green body. Then the green body is placed in the oven for drying at 100° C. for 12 h.

In step 4: the green body prepared in the step 3 is placed in a graphite crucible, then the graphite crucible is placed in a multi-functional sintering furnace. Nitrogen gas is introduced into the multi-functional sintering furnace as a protective atmosphere. The graphite crucible is firstly heated from room temperature to a first temperature of 1100° C. at a rate of 10° C./min, then heated from the first temperature of 1100° C. to a second temperature of 1250° C. at a rate of 5° C./min, and the second temperature is kept for 2 h, finally the graphite crucible is cooled down to the room temperature with the multi-functional sintering furnace to obtain a sample.

In step 5: a surface of the sample obtained in the step 4 is ground to obtain a ground sample, using sandpapers of 200 mesh, 400 mesh and 800 mesh in sequence. Aluminum is then sprayed onto top and bottom surfaces of the ground sample using a thermal spray machine to a thickness of 10 μm, then dried in the oven at a temperature of 100° C. to obtain the carbon composite ceramic linear resistor.

### Embodiment 8

A preparation method of a carbon composite ceramic linear resistor is provided in the embodiment, including the following steps 1-5.

In step 1: pretreatment of raw materials is as follows. Silicon carbide powder, bentonite and nano carbon black are placed in an oven for drying at 80° C. for 2 h.

In step 2: 60 vol % of the silicon carbide powder, 36 vol % of the bentonite and 4 vol % of the nano carbon black are measured accurately. The silicon carbide powder, the nano carbon black and the bentonite are mixed to obtain a powder mixture. Anhydrous ethanol is measured according to a volume ratio of 3:1 relative to the powder mixture. The powder mixture and the anhydrous ethanol are placed into a ball mill. The powder mixture and the anhydrous ethanol are mixed and ball-milled at a rotational speed of 200 rpm for 12 h, then dried and sieved to obtain a uniformly mixed powder.

In step 3: a 5 wt % polyvinyl alcohol solution is added to the uniformly mixed powder to obtain a mixture. An addition amount of the polyvinyl alcohol solution is 10% of a mass of the uniformly mixed powder. The mixture is used to form a green body through a compression molding method. The compression molding method includes subjecting the mixture to a pressure of 75 MPa in a bidirectional pressing mode with a holding time of 60 seconds to obtain the green body. Then the green body is placed in the oven for drying at 100° C. for 12 h.

In step 4: the green body prepared in the step 3 is placed in a graphite crucible, then the graphite crucible is placed in a multi-functional sintering furnace. Nitrogen gas is introduced into the multi-functional sintering furnace as a protective atmosphere. The graphite crucible is firstly heated from room temperature to a first temperature of 1100° C. at a rate of 10° C./min, then heated from the first temperature of 1100° C. to a second temperature of 1300° C. at a rate of 5° C./min, and the second temperature is kept for 2 h, finally the graphite crucible is cooled down to the room temperature with the multi-functional sintering furnace to obtain a sample.

In step 5: a surface of the sample obtained in the step 4 is ground to obtain a ground sample, using sandpapers of 200 mesh, 400 mesh and 800 mesh in sequence. Aluminum is then sprayed onto top and bottom surfaces of the ground sample using a thermal spray machine to a thickness of 10 μm, then dried in the oven at a temperature of 100° C. to obtain the carbon composite ceramic linear resistor.

### Embodiment 9

A preparation method of a carbon composite ceramic linear resistor is provided in the embodiment, including the following steps 1-5.

In step 1: pretreatment of raw materials is as follows. Silicon carbide powder, bentonite and nano carbon black are placed in an oven for drying at 80° C. for 2 h.

In step 2: 60 vol % of the silicon carbide powder, 36 vol % of the bentonite and 4 vol % of the nano carbon black are measured accurately. The silicon carbide powder, the nano carbon black and the bentonite are mixed to obtain a powder mixture. Anhydrous ethanol is measured according to a volume ratio of 3.2:1 relative to the powder mixture. The powder mixture and the anhydrous ethanol are placed into a ball mill. The powder mixture and the anhydrous ethanol are mixed and ball-milled at a rotational speed of 100 rpm for 16 h, then dried and sieved to obtain a uniformly mixed powder.

In step 3: a 5 wt % polyvinyl alcohol solution is added to the uniformly mixed powder to obtain a mixture. An addition amount of the polyvinyl alcohol solution is 5% of a mass of the uniformly mixed powder. The mixture is used to form a green body through a compression molding method. The compression molding method includes subjecting the mixture to a pressure of 80 MPa in a bidirectional pressing mode with a holding time of 60 seconds to obtain the green body. Then the green body is placed in the oven for drying at 100° C. for 12 h.

In step 4: the green body prepared in the step 3 is placed in a graphite crucible, then the graphite crucible is placed in a multi-functional sintering furnace. Nitrogen gas is introduced into the multi-functional sintering furnace as a protective atmosphere. The graphite crucible is firstly heated from room temperature to a first temperature of 1100° C. at a rate of 10° C./min, then heated from the first temperature of 1100° C. to a second temperature of 1300° C. at a rate of 5° C./min, and the second temperature is kept for 3 h, finally the graphite crucible is cooled down to the room temperature with the multi-functional sintering furnace to obtain a sample.

In step 5: a surface of the sample obtained in the step 4 is ground to obtain a ground sample, using sandpapers of 200 mesh, 400 mesh and 800 mesh in sequence. Aluminum is then sprayed onto top and bottom surfaces of the ground sample using a thermal spray machine to a thickness of 12 μm, then the sample is dried in the oven at a temperature of 100° C. to obtain the carbon composite ceramic linear resistor.

### Embodiment 10

A preparation method of a carbon composite ceramic linear resistor is provided in the embodiment, including the following steps 1-5.

In step 1: pretreatment of raw materials is as follows. Silicon carbide powder, bentonite and nano carbon black are placed in an oven for drying at 80° C. for 2 h.

In step 2: 60 vol % of the silicon carbide powder, 3 vol % of the bentonite and 4 vol % of the nano carbon black are measured accurately. The silicon carbide powder, the nano carbon black and the bentonite are mixed to obtain a powder mixture. Anhydrous ethanol is measured according to a volume ratio of 3.5:1 relative to the powder mixture. The powder mixture and the anhydrous ethanol are placed into a ball mill. The powder mixture and the anhydrous ethanol are mixed and ball-milled at a rotational speed of 300 rpm for 10 h, then dried and sieved to obtain a uniformly mixed powder.

In step 3: a 5 wt % polyvinyl alcohol solution is added to the uniformly mixed powder to obtain a mixture. An addition amount of the polyvinyl alcohol solution is 7% of a mass of the uniformly mixed powder. The mixture is used to form a green body through a compression molding method. The compression molding method includes subjecting the mixture to a pressure of 100 MPa in a bidirectional pressing mode with a holding time of 60 seconds to obtain the green body. Then the green body is placed in the oven for drying at 100° C. for 12 h.

In step 4: the green body prepared in the step 3 is placed in a graphite crucible, then the graphite crucible is placed in a multi-functional sintering furnace. Nitrogen gas is introduced into the multi-functional sintering furnace as a protective atmosphere. The graphite crucible is firstly heated from room temperature to a first temperature of 1100° C. at a rate of 10° C./min, then heated from the first temperature of 1100° C. to a second temperature of 1200° C. at a rate of 5° C./min, and the second temperature is kept for 4 h, finally the graphite crucible is cooled down to the room temperature with the multi-functional sintering furnace to obtain a sample.

In step 5: a surface of the sample obtained in the step 4 is ground to obtain a ground sample, using sandpapers of 200 mesh, 400 mesh and 800 mesh in sequence. Aluminum is then sprayed onto top and bottom surfaces of the ground sample using a thermal spray machine to a thickness of 15 μm, then the sample is dried in the oven at a temperature of 100° C. to obtain the carbon composite ceramic linear resistor.

### Comparative Embodiment 1

A preparation method of a carbon-ceramic linear material is provided in the comparative embodiment, including the following steps 1-5.

In step 1: pretreatment of raw materials is as follows. Alumina powder, bentonite and nano carbon black are placed in an oven for drying at 80° C. for 2 h.

In step 2: 60 vol % of the alumina powder, 36 vol % of the bentonite and 4 vol % of the nano carbon black are measured accurately. The alumina powder, the nano carbon black and the bentonite are mixed to obtain a powder mixture. Anhydrous ethanol is measured according to a volume ratio of 3:1 relative to the powder mixture. The powder mixture and the anhydrous ethanol are placed into a ball mill. The powder mixture and the anhydrous ethanol are mixed and ball-milled at a rotational speed of 200 rpm 12 h, then dried and sieved to obtain a uniformly mixed powder.

In step 3: a 5 wt % polyvinyl alcohol solution is added to the uniformly mixed powder to obtain a mixture. An addition amount of the polyvinyl alcohol solution is 10% of a mass of the uniformly mixed powder. The mixture is used to form a green body through a compression molding method. The compression molding method includes subjecting the mixture to a pressure of 75 MPa in a bidirectional pressing mode with a holding time of 60 seconds to obtain the green body. Then the green body is placed in the oven for drying at 100° C. for 12 h.

In step 4: the green body prepared in the step 3 is placed in a graphite crucible, then the graphite crucible is placed in a multi-functional sintering furnace. Nitrogen gas is introduced into the multi-functional sintering furnace as a protective atmosphere. The graphite crucible is firstly heated from room temperature to a first temperature of 1100° C. at a rate of 10° C./min, then heated from the first temperature of 1100° C. to a second temperature of 1150° C. at a rate of 5° C./min, and the second temperature is kept at 1150° C. for 2 h, finally the graphite crucible is cooled down to the room temperature with the multi-functional sintering furnace to obtain a sample.

In step 5: a surface of the sample obtained in the step 4 is ground to obtain a ground sample, using sandpapers of 200 mesh, 400 mesh and 800 mesh in sequence. Aluminum is then sprayed onto top and bottom surfaces of the ground sample using a thermal spray machine to a thickness of 10 μm, then dried in the oven at a temperature of 100° C. to obtain the carbon-ceramic linear material.

### Comparative Embodiment 2

A preparation method of a carbon-ceramic linear material is provided in the comparative embodiment, including the following steps 1-5.

In step 1: pretreatment of raw materials is as follows. Alumina powder, bentonite and nano carbon black are placed in an oven for drying at 80° C. for 2 h.

In step 2: 60 vol % of the alumina powder, 33 vol % of the bentonite and 7 vol % of the nano carbon black are measured accurately. The alumina powder, the nano carbon black and the bentonite are mixed to obtain a powder mixture. Anhydrous ethanol is measured according to a volume ratio of 3:1 relative to the powder mixture. The powder mixture and the anhydrous ethanol are placed into a ball mill. The powder mixture and the anhydrous ethanol are mixed and ball-milled at a rotational speed of 200 rpm for 12 h, then dried and sieved to obtain a uniformly mixed powder.

In step 3: a 5 wt % polyvinyl alcohol solution is added to the uniformly mixed powder to obtain a mixture. An addition amount of the polyvinyl alcohol solution is 10% of a mass of the uniformly mixed powder. The mixture is used to form a green body through a compression molding method. The compression molding method includes subjecting the mixture to a pressure of 75 MPa in a bidirectional pressing mode with a holding time of 60 seconds to obtain the green body. Then the green body is placed in the oven for drying at 100° C. for 12 h.

In step 4: the green body prepared in the step 3 is placed in a graphite crucible, then the graphite crucible is placed in a multi-functional sintering furnace. Nitrogen gas is introduced into the multi-functional sintering furnace as a protective atmosphere. The graphite crucible is firstly heated from room temperature to a first temperature of 1100° C. at a rate of 10° C./min, then heated from the first temperature of 1100° C. to a second temperature of 1150° C. at a rate of 5° C./min, and the second temperature is kept at 1150° C. for 2 h, finally the graphite crucible is cooled down to the room temperature with the multi-functional sintering furnace to obtain a sample.

In step 5: a surface of the sample obtained in the step 4 is ground to obtain a ground sample, using sandpapers of 200 mesh, 400 mesh and 800 mesh in sequence. Aluminum is then sprayed onto top and bottom surfaces of the ground sample using a thermal spray machine to a thickness of 10 μm, then dried in the oven at a temperature of 100° C. to obtain the carbon-ceramic linear material.

### Comparative Embodiment 3

A preparation method of a carbon-ceramic linear material is provided in the comparative embodiment, including the following steps 1-5.

In step 1: pretreatment of raw materials is as follows. Alumina powder, bentonite and nano carbon black are placed in an oven for drying at 80° C. for 2 h.

In step 2: 60 vol % of the alumina powder, 30 vol % of the bentonite and 10 vol % of the nano carbon black are measured accurately. The alumina powder, the nano carbon black and the bentonite are mixed to obtain a powder mixture. Anhydrous ethanol is measured according to a volume ratio of 3:1 relative to the powder mixture. The powder mixture and the anhydrous ethanol are placed into a ball mill. The powder mixture and the anhydrous ethanol are mixed and ball-milled at a rotational speed of 200 rpm for 12 h, then dried and sieved to obtain a uniformly mixed powder.

In step 3: a 5 wt % polyvinyl alcohol solution is added to the uniformly mixed powder to obtain a mixture. An addition amount of the polyvinyl alcohol solution is 10% of a mass of the uniformly mixed powder. The mixture is used to form a green body through a compression molding method. The compression molding method includes subjecting the mixture to a pressure of 75 MPa in a bidirectional pressing mode with a holding time of 60 seconds to obtain the green body. Then the green body is placed in the oven for drying at 100° C. for 12 h.

In step 4: the green body prepared in the step 3 is placed in a graphite crucible, then the graphite crucible is placed in a multi-functional sintering furnace. Nitrogen gas is introduced into the multi-functional sintering furnace as a protective atmosphere. The graphite crucible is firstly heated from room temperature to a first temperature of 1100° C. at a rate of 10° C./min, then heated from the first temperature of 1100° C. to a second temperature of 1150° C. at a rate of 5° C./min, and the second temperature is kept at 1150° C. for 2 h, finally the graphite crucible is cooled down to the room temperature with the multi-functional sintering furnace to obtain a sample.

In step 5: a surface of the sample obtained in the step 4 is ground to obtain a ground sample, using sandpapers of 200 mesh, 400 mesh and 800 mesh in sequence. Aluminum is then sprayed onto top and bottom surfaces of the ground sample using a thermal spray machine to a thickness of 10 μm, then dried in the oven at a temperature of 100° C. to obtain the carbon-ceramic linear material.

### Comparative Embodiment 4

A preparation method of a carbon-ceramic linear material is provided in the comparative embodiment, including the following steps 1-5.

In step 1: pretreatment of raw materials is as follows. Alumina powder, bentonite and flake graphite are placed in an oven for drying at 80° C. for 2 h.

In step 2: 60 vol % of the alumina powder, 26 vol % of the bentonite and 14 vol % of the flake graphite are measured accurately. The alumina powder, the flake graphite and the bentonite are mixed to obtain a powder mixture. Anhydrous ethanol is measured according to a volume ratio of 3:1 relative to the powder mixture. The powder mixture and the anhydrous ethanol are placed into a ball mill. The powder mixture and the anhydrous ethanol are mixed and ball-milled at a rotational speed of 200 rpm for 12 h, then dried and sieved to obtain a uniformly mixed powder.

In step 3: a 5 wt % polyvinyl alcohol solution is added to the uniformly mixed powder to obtain a mixture. An addition amount of the polyvinyl alcohol solution is 10% of a mass of the uniformly mixed powder. The mixture is used to form a green body through a compression molding method. The compression molding method includes subjecting the mixture to a pressure of 75 MPa in a bidirectional pressing mode with a holding time of 60 seconds to obtain the green body. Then the green body is placed in the oven for drying at 100° C. for 12 h.

In step 4: the green body prepared in the step 3 is placed in a graphite crucible, then the graphite crucible is placed in a multi-functional sintering furnace. Nitrogen gas is introduced into the multi-functional sintering furnace as a protective atmosphere. The graphite crucible is firstly heated from room temperature to a first temperature of 1100° C. at a rate of 10° C./min, then heated from the first temperature of 1100° C. to a second temperature of 1150° C. at a rate of 5° C./min, and the second temperature is kept at 1150° C. for 2 h, finally the graphite crucible is cooled down to the room temperature with the multi-functional sintering furnace to obtain a sample.

In step 5: a surface of the sample obtained in the step 4 is ground to obtain a ground sample, using sandpapers of 200 mesh, 400 mesh and 800 mesh in sequence. Aluminum is then sprayed onto top and bottom surfaces of the ground sample using a thermal spray machine to a thickness of 10 μm, then dried in the oven at a temperature of 100° C. to obtain the carbon-ceramic linear material.

Bulk density and porosity of specimens of the carbon composite ceramic linear resistor and the carbon-ceramic linear material respectively prepared in the embodiments and in the comparative embodiments are measured via an Archimedes water-displacement method. Electrical resistivity is measured by a four-probe method, and thermal conductivity is measured by a laser flashing method. Thermal shock resistance of the specimens is measured by a water quenching test. The water quenching test includes the following processes. The specimens are placed in an electric furnace and heated stepwise to 220° C. to 820° C., and an initial temperature difference is 200° C. Each specimen is heated in a resistance-wire furnace at a rate of 10° C./min to a target temperature, and held for 10 min. Then the specimen is withdrawn from the resistance-wire furnace and immediately plunged into deionized water at 20±3° C. for 10 seconds to cool down. The specimen is removed from the deionized water, then dried at 110° C. for 2 h, and cooled down naturally to a room temperature. Residual flexural strength of the specimens is then tested. If a residual rate of the flexural strength after water quenching is higher than 70%, increase the initial temperature difference by 100° C. and repeat the process of the water quenching test mentioned above until the residual rate of the flexural strength of the specimen is lower than 70%. It should be noted that the specimen to be tested next should be tested after a temperature of the deionized water has changed to the room temperature. Residual flexural strength is measured by a three-point bending test. A temperature difference corresponding to when the residual flexural strength drops to 70% of the flexural strength before thermal shocking is the critical thermal shock temperature difference. The measured properties are presented in Table 1.

TABLE 1
Properties of the specimens prepared in the embodiments
and the comparative embodiments of the disclosure.

| | | Critical | | |
|---|---|---|---|---|
| | | thermal | | |
| | | shock | Thermal | |
| | Electrical | temperature | conductivity/ | |
| | resistivity/ | difference/ | W · m⁻¹ · | |
| | Ω · m | ° C. | K⁻¹ | Porosity/% |
| Embodiment 1 | 2.25 | 389.92 | 9.35 | 29.5 |
| Embodiment 2 | 3.07 | 374.63 | 7.94 | 28.7 |
| Embodiment 3 | 4.22 | 349.71 | 6.86 | 27.1 |
| Embodiment 4 | 0.54 | 362.46 | 7.08 | 31.4 |
| Embodiment 5 | 10.48 | 405.61 | 11.73 | 26.6 |
| Embodiment 6 | 1.67 | 378.38 | 9.56 | 29.3 |
| Embodiment 7 | 1.82 | 370.49 | 9.67 | 28.7 |
| Embodiment 8 | 1.92 | 350.84 | 9.84 | 27.5 |
| Embodiment 9 | 1.73 | 368.46 | 9.91 | 26.9 |
| Embodiment 10 | 1.54 | 382.45 | 9.62 | 28.8 |
| Comparative | 42.43 | 320.56 | 2.81 | 28.2 |
| embodiment 1 | | | | |
| Comparative | 12.25 | 304.54 | 2.64 | 27.7 |
| embodiment 2 | | | | |
| Comparative | 13.77 | 271.55 | 2.32 | 32.1 |
| embodiment 3 | | | | |
| Comparative | 3.68 | 280.74 | 2.55 | 29.9 |
| embodiment 4 | | | | |

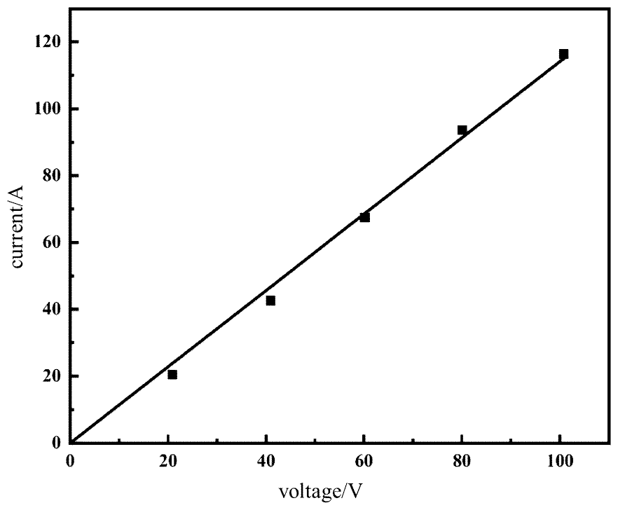

A voltage-current characteristic curve of the carbon composite ceramic linear resistor prepared in the embodiment 1 using the silicon carbide as an aggregate is shown in FIG. 1. As shown in FIG. 1, the voltage and the current of the carbon composite ceramic resistor prepared using the silicon carbide exhibit a linear relationship, indicating that the carbon composite ceramic resistor of the disclosure is a linear resistor.

Comparing the embodiment 1 with the comparative embodiment 1, it is evident that, at the same volume fraction of aggregate addition, replacing alumina with the silicon carbide as the aggregate significantly improves the electrical conductivity and the thermal shock resistance of the carbon composite ceramic linear resistor prepared in the embodiment 1. This is because an introduction of the silicon carbide increases the number of conductive pathways within the carbon composite ceramic linear resistor, thereby reducing electrical resistivity. The thermal conductivity is also significantly enhanced, alleviating a temperature difference between an interior and an exterior of the carbon composite ceramic linear resistor during water quenching and reducing the resulting thermal stress.

Comparative embodiments 1, 2, and 3 demonstrate that, in a system using the alumina as the aggregate, although increasing a content of the nano carbon black can reduce electrical resistivity, excessively high carbon content makes the carbon-ceramic linear material difficult to sinter. Furthermore, the nano carbon black reacts with iron oxide impurities in the bentonite via a carbothermal reduction reaction, releasing gases that ultimately cause the specimens expansion. This increases contact resistance between carbon black particles, resulting in an increase of the electrical resistivity of the specimens instead of a decrease. Based on this, the disclosure introduces the silicon carbide, used in combination with the bentonite and the nano carbon black, effectively reducing the electrical resistivity.

Comparing embodiment 1 with comparative embodiments 2 and 4, it is apparent that although increasing a content of flake graphite can reduce resistivity, the thermal shock resistance is lower than that of the specimens using the silicon carbide. This is because adding excessive amounts of graphite reduces the density and the thermal conductivity of the specimens using the flake graphite, thereby increasing the thermal stress experienced during water quenching.

Although some embodiments of the disclosure have been described, those skilled in the art will recognize the fundamental inventive concepts and thus be able to make additional changes and modifications to these embodiments. Therefore, the appended claims are intended to be interpreted as including the embodiments mentioned above as well as all changes and modifications falling within the scope of the disclosure.

It is apparent that those skilled in the art can make various modifications and variations to the disclosure without departing from the spirit and scope of the disclosure. Thus, if such modifications and variations of the disclosure fall within the scope of the claims of the disclosure and their equivalent technologies, it is intended that the disclosure include such modifications and variations.

What is claimed is:

1. A preparation method of a carbon composite ceramic linear resistor, comprising:
mixing bentonite, silicon carbide and nano carbon black uniformly to obtain a powder mixture; mixing the powder mixture and ethyl alcohol uniformly and drying to obtain a uniformly mixed powder; adding a binder solution to obtain a mixture; performing compression molding on the mixture to form a green body; wherein the powder mixture comprises following components by volume percentage: 33% to 56% of the bentonite, 40% to 60% of the silicon carbide, 1% to 7% of the nano carbon black, with a total volume amounting to 100%;
holding the green body at a temperature ranging from 1150 Celsius degrees (° C.) to 1300° C. under a nitrogen-containing gas atmosphere, thereby obtaining a sample; and
grinding the sample to obtain a ground sample and then spraying aluminum on the ground sample to obtain the carbon composite ceramic linear resistor.

2. The preparation method of the carbon composite ceramic linear resistor as claimed in claim 1, wherein time for holding the temperature is in a range of 2 hours (h) to 4 h.

3. The preparation method of the carbon composite ceramic linear resistor as claimed in claim 1, wherein pressure of the compression molding is in a range of 75 megapascals (MPa) to 100 MPa.

4. The preparation method of the carbon composite ceramic linear resistor as claimed in claim 1, wherein an addition amount of the binder solution is in a range of 5% to 10% of a mass of the powder mixture, and a mass concentration of the binder solution is 5%.

5. The preparation method of the carbon composite ceramic linear resistor as claimed in claim 1, wherein the binder solution comprises polyvinyl alcohol.

6. The preparation method of the carbon composite ceramic linear resistor as claimed in claim 1, wherein a volume ratio of the powder mixture and the ethyl alcohol is in a range of 3:1 to 3.5:1.

7. The preparation method of the carbon composite ceramic linear resistor as claimed in claim 1, wherein the mixing the powder mixture and ethyl alcohol comprises: mixing at a ball-milling speed ranging from 100 revolutions per minute (rpm) to 300 rpm for 10 h to 16 h.

8. The preparation method of the carbon composite ceramic linear resistor as claimed in claim 1 wherein a thickness of the aluminum sprayed on the ground sample is in a range of 10 micrometers (μm) to 15 μm.

9. A carbon composite ceramic linear resistor, prepared by the preparation method of the carbon composite ceramic linear resistor as claimed in claim 1.
